(19) United States
(12) Patent Application Publication
(10) Pub. No.: US 2007/0148408 A1
(43) Pub. Date: Jun. 28, 2007

(54) Method for simulating raised-stone ornaments on a surface of three-dimensional decoration and its formation

(76) Inventor: Chi-Ping Huang, Taipei City (TW)

Correspondence Address: Troxell Law Office Pllc, Suite 1404, 5205 Leesburg Pike, Falls Church, VA, 22041, US

(21) Appl. No.: 11/315,485

(22) Filed: Dec. 23, 2005

(51) Int. Cl. E01F 9/04; B27N 3/00

(52) U.S. Cl. 428/143; 264/109

(57) ABSTRACT

A method for simulating raised-stone ornaments on a surface of three-dimensional decoration and its formation, and more particularly to a simulation method which can provide the raised-stone ornaments on the surface of decoration, such that an ornament with a distribution of raised-stone particles can be formed on the surface of decoration, is primarily using a bonding agent, to which a pickling operation can be performed, to fill in the decorating stone crumbs and to perform a blending operation by a certain proportion, followed by performing a molding and solidification and then pickling the surface with an aciding agent, so as to expose out the stone crumbs close to the surface.

### BACKGROUND OF THE INVENTION

(a) Field of the Invention

The present invention relates to a method for simulating raised-stone ornaments on a surface of three-dimensional decoration and its formation, and more particularly to a simulation method which can provide the raised-stone ornaments on the surface of decoration.

(b) Description of the Prior Art

A general method for forming rough particles on a surface of decoration is to coat an adhesive on a surface of molded object after setting an expected pattern thereof, and finally to install stone crumbs on a surface of adhesive, so as to simulate a pattern of raised-stone ornaments on the surface of decoration.

In a conventional method of spreading the stone crumbs on the surface of decoration, as only a single face of stone crumb is in contact with the surface of decoration (on the surface of adhesive), and the adhesive used is generally made by a resin or organic compound, the adhesive can be disintegrated by moisture or its elements can be cracked due to an exposure to an ultraviolet radiation, allowing the stone crumbs to easily fall off.

### SUMMARY OF THE INVENTION

Accordingly, in the present invention, a bonding agent is used to bond stone crumbs and a pickling is performed on their surfaces after molding the blended mixture, so as to expose the stones, thereby achieving the following advantages:
1. The stone crumbs can be filled in a body of decoration.
2. The stones are partly exposed and the unexposed part is firmly bonded by the bonding agent, therefore they will not easily fall off.
3. A depth of exposure of the stones can be changed through a time control of the pickling process, thereby forming different heights of exposure.
4. The stones used for decorating can be chosen from ores of different colors, thereby forming various stone patterns on the surface of decoration.

The primary object of present invention is to manufacture a three-dimensional body of decoration, by filling a bonding agent into stone crumbs for decorating, forming a pulp after blending, and then performing a molding operation. After solidifying the decoration body, a pickling is performed on its surface to wash the bonding agent which is not tolerated to acid and to descend its surface height. On the contrary, the height of exposure of stone crumbs close to the surface of decoration body can be controlled through a change of pickling depth. Basically, a half height of stone is deeply contained in the bonding agent; whereas the other half height is exposed to form a raised ornament, thereby firmly bonding the stone crumbs for decorating to prevent from a falling off.

Another object of the present invention is to use a pulp after being blended as a three-dimensional solid ornament or a three-dimensional hollow ornament, depending on different methods of operation. The primary common point is that a pickling is performed to an external surface of the accomplished solid or hollow ornament, so as to expose the stone crumbs at locations close to the surface of decoration body.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of forming a surface of raised-stones on a surface of decoration of the present invention.

FIG. 2 shows a flow diagram of the present invention.

FIG. 3 shows a schematic view of performing a molding operation in a mold cavity of the present invention.

FIG. 4 shows a schematic view of performing a molding operation in a mold cavity to manufacture a hollow ornament of the present invention.

FIG. 5 shows a cutaway view of an accomplished decoration body of the present invention.

FIG. 6 shows a cutaway view of performing a pickling on a surface of FIG. 5.

FIG. 7 shows a cutaway view of decorating crumbs being exposed opposing to a bonding agent of the present invention.

### DETAILED DESCRIPTION OF THE PREFERRED EMBODIMENTS

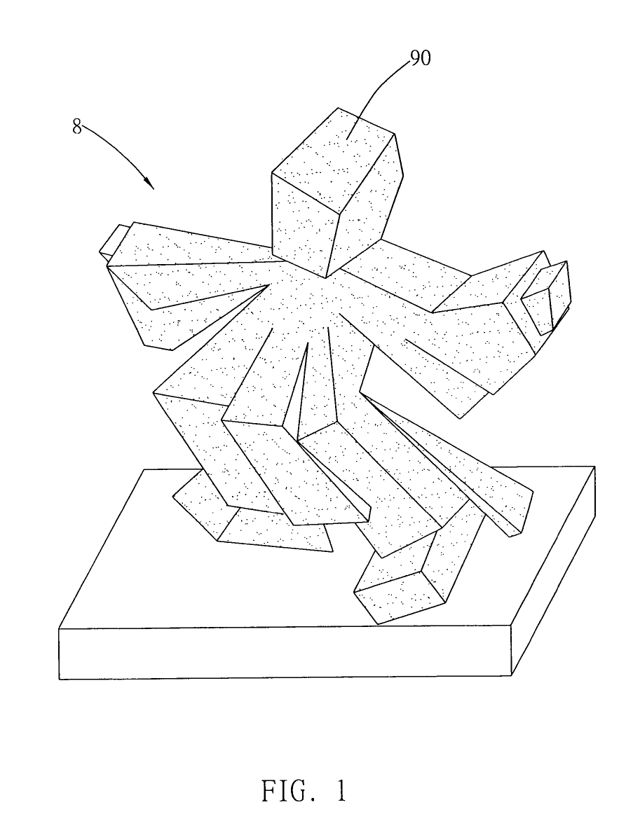

Referring to FIG. 1, a three-dimensional decoration 8 includes a plane of raised-stone 90 on its surface to manifest an emulated stone pattern or an ornament with a rough surface on the surface thereof; the plane of raised-stone 90 is composed of a plurality of stone crumbs 9.

In addition to a doll in a shape of human body, the three-dimensional decoration 8 can be manufactured into a stone house, a flat stone plate, or a cylindrical stone post.

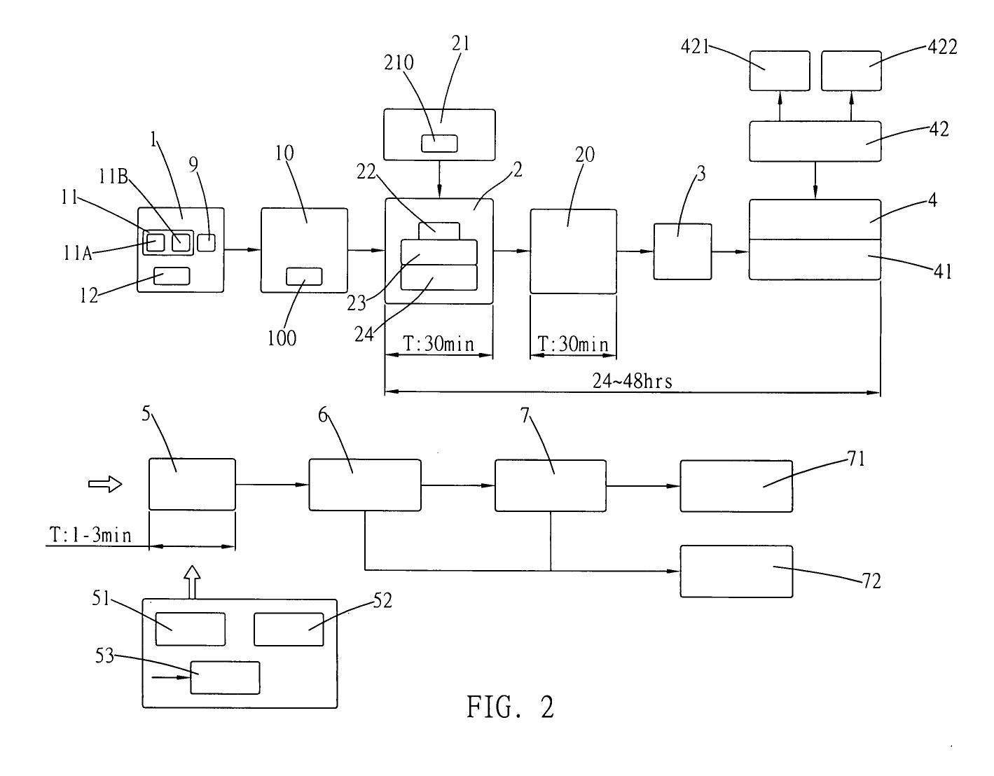

Referring to FIG. 2, a basic procedure of the present invention is to perform a setup operation 1 first, wherein a bonding agent 11 is mixed with decorating stone crumbs 9. The bonding agent 11 is made by uniformly tuning a magnesium chloride solution and a magnesium oxide powder in a weight ratio of 1:1.2 to 1:1.5. Next, the bonding agent 11 is mixed into the decorating stone crumbs 9 being crushed or in tiny particles with a solvent ratio of 1:1. In order to allow the bonding agent 11 to have a larger mechanical stress in bonding, a proper amount of fiber yarns 12 is filled in the bonding agent 11, so as to form a dragging function to enhance its mechanical strength by using a toughness of the fiber yarns 12.

After accomplishing the aforementioned setup operation 1 according to the ratios, a blending operation 100 is performed to form a pulp 100 which will be provided to a molding operation 2.

After accomplishing the molding operation 2, a setting operation 20 is performed by a stewing method. The setting operation 20 will be proceeding for 30 minutes before performing a demolding operation 3.

After demolding, a natural solidification reaction 4 is carried on in a store-up condition. During the solidification reaction 4, a maintenance operation 41 can be performed including an appearance inspection 42 whose purpose is to inspect edges or surface cavities, so as to perform an edge fixing operation 421 or a repairing operation 422. The aforementioned maintenance operation 41 will be taking 24-48 hours before accomplishing.

Following the complete solidification, a surface eroding operation 5 is performed and will be taking about 1-3 minutes, which includes a pre-processing operation of eroding by a 10% of aciding agent 51 diluted with fresh water and then entering into a pickling tank 53.

The product accomplished from the aforementioned procedures will be entered into the pickling tank 53 to perform the surface eroding operation 5 for about 1-3 minutes. Next, it is taken out and its surface is processed by a residual scrubbing operation 6.

Due to that a part of residual material with a higher stability will be left on the eroded surface after eroding the aforementioned bonding agent 11 with the aciding agent 51, the residual scrubbing operation 6 should be performed.

Then, a neutralization operation 7 with fresh water is performed on the surface, followed by carrying on a drying operation 71. Waste water formed following the residual scrubbing operation 6 or the neutralization operation 7 is processed by a waste-water treatment 72 to prevent from an environmental pollution.

At the step of molding operation 2 of the present invention, any kind of molding methods can be used to manufacture the expected three-dimensional decoration body, wherein a mold manufacturing 21 can be used to make a molding tool 210 and a solid or hollow manufacturing method can be used to perform the molding. For manufacturing the solid decoration, a mold injection operation 23 can be used; whereas, for the hollow decoration, a centrifugal or cladding method can be used to perform a shell molding 24.

Before performing the mold injection 23 or shell molding 24, a mold cavity surface wiping operation 22 is performed on a surface of molding tool 210 in advance, in order to make sure that the pulp 100 can be completely distributed on an inner surface of mold cavity, thereby preventing a generation of air bubbles or wounded holes on a surface of molded object.

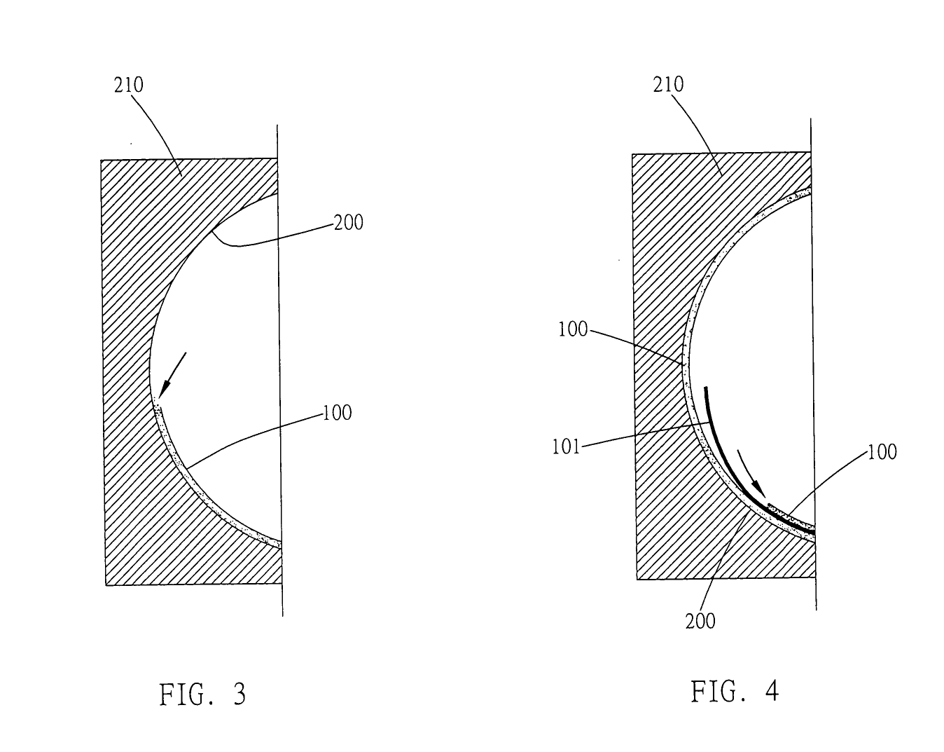

Referring to FIG. 3 and FIG. 4, a spraying or brushing method can be used in performing the surface wiping operation 22 on the inner surface 200 of mold cavity of the molding tool 210 required by the aforementioned molding operation 2, in order to coat the inner surface 200 with a layer of pulp 100 in advance.

After coating the mold cavity with the pulp 100, a grouting is directly performed to accomplish a basic molded body of the three-dimensional solid decoration, if the mold injection operation 23 is taken. After accomplishing the aforementioned grouting operation, a de-bubbling operation will be carried on according to requirement. In the de-bubbling operation, a vibration method is generally used to acquire a kinetic energy of moving by shock wave energy in association with a mass of elements of pulp. In addition, a descending gravitational force is formed by a force of gravitation of earth, thereby separating the air bubbles. On the other hand, a residual air can be removed by a negative pressure arising from implementing a vacuum operation, which can also achieve a purpose of de-bubbling.

If a three-dimensional hollow decoration needs to be manufactured, then the pulp 100 is first coated on the inner surface 200 of molding tool 210, which is the same as the aforementioned operation for manufacturing the three-dimensional solid decoration.

Referring to FIG. 4, after distributing the pulp 100 on the inner surface 200 of molding tool 210, a layer of fiber cloth 101 in a shape of lump is pasted on the pulp 100 followed by distributing an innermost layer of pulp 100, thereby forming a kind of interlining. By a fixing function of fiber cloth 101, the mechanical intensity can be enhanced to prevent from fracturing, thereby forming a molding operation to the three-dimensional hollow decoration.

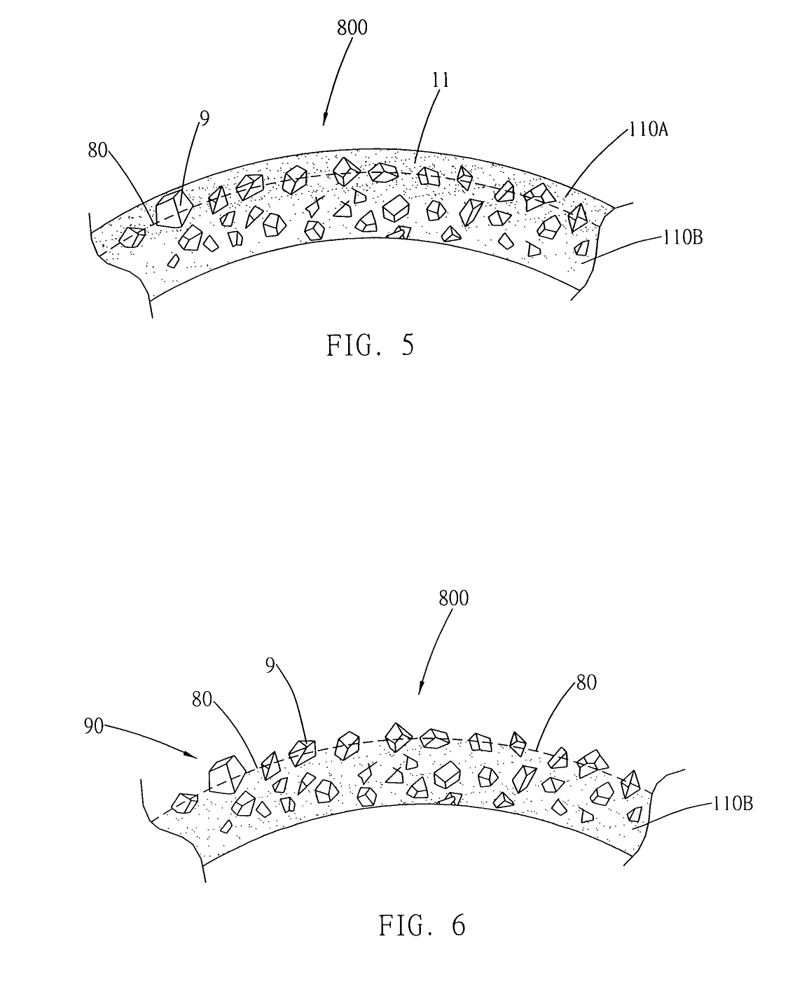

Referring to FIG. 5 and FIG. 6, after accomplishing the basic molded body of decoration in the aforementioned procedures and after performing the solidification reaction 4 as shown in FIG. 1, a decoration body 800 is formed. As shown in FIG. 5, it is a cutaway view manifesting a relation among all of the components of the decoration body 800.

The stone crumbs 9 are bonded with the bonding agent 11, followed by pickling the entire surface. A pickling depth is specified at a position of expected surface line 80, therefore, a preset cover bonding agent 11A and a body bonding agent 11B are separated above and below the expected surface line 80.

According to the depth of expected surface line 80, the aforementioned decoration body 800 is left with the body bonding agent 11B after pickling. As the stone crumbs 9 will be exposed by pickling the cover bonding agent 11A above the surface line 80, a plane of raised-stone 90 will be formed by the plurality of stone crumbs 9.

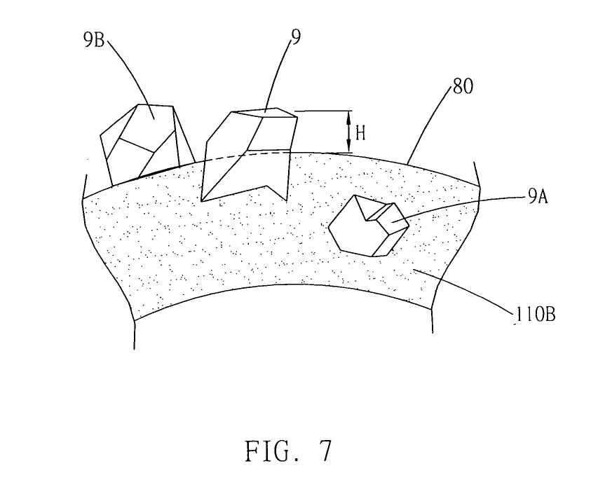

Referring to FIG. 7, the stone crumbs 9 are exposed out of the surface toward an external side, and are bonded by the body bonding agent 11B toward an interior side; therefore, a part of the stone crumbs 9A are contained in the body bonding agent 11B. The contained part can be taken as a filling material, and a raised-shape ornament is formed on an external surface with the stone crumbs 9 exposed out of the surface line 80.

A height H of exposure of the stone crumbs 9 is determined by a height of the surface line 80, and it is better to have at least a half height of the stone crumbs contained by the body bonding agent 11B.

As the bonding agent 11B is provided with a viscosity, the stone crumbs 9 can be also assembled on a surface position of surface line 80 with one face, thereby exposing at least five faces of a three-dimensional ornament (except for the adhesive face).

Through an implementation of FIG. 3 to FIG. 7, the present invention basically uses the bonding agent 11 to directly bond the decorating stone crumbs 9 which can be made by silicon grits of glass or any kind of stone fragments to simulate a plane of different colors or a various kind of stone patterns.

The decoration manufactured is basically a three-dimensional decoration, such as a doll or a decoration for simulating a building, and a flat plate or a tube.

Basically, the plane of raised-stone 90 will be formed after performing the pickling operation as shown in FIG. 5 and FIG. 6, so as to achieve a simulation of raised-stone ornament. A part of stone crumbs will be bonded by the bonding agent 11, therefore, the stone crumbs 9 will not easily fall off, and a variation of height raised from the stones will be available by a change of pickling depth using a time control of pickling.

Different effects of backlighting will be formed on a surface of finished product, after being impinged by an external light flow in a single orientation, due to a style of various depths. Accordingly, different changes of spectacle (shadow) will be generated, and various visual beauties will be manifested. However, the basic principle of pickling depth is to enable a bottom of stone crumb to be bonded by the body bonding agent.

The bonding agent 11 used in the present invention is a mixture of magnesium chloride solution and magnesium oxide powder, which is basically an agent that is not tolerated to acid but is waterproof. To enhance its waterproof capability, about 1% of moisture-proof modifying agent can be added to the pulp according to a proportion of pulp, thereby generating an explicit moisture-proof effect.

Furthermore, in order to obtain a possible residual stress which occurs in a relative contraction resulting from the solidification process, about 10-15 mm of fiber yarns will be added in the pulp. By using the fiber yarns to form a distribution of buckling in the pulp during the mixing process, a fixing function can be formed with the fiber yarns to interconnect molecules of bonding agent, thereby achieving an enhancement of mechanical bonding strength, after solidifying.

The primary principle of present invention is to mix the decorating stone crumbs with the bonding agent, and to perform the pickling to the entire surface for washing into a depth after solidifying, so as to expose the stone crumbs which are close to the surface, thereby achieving an object of exposing the ornament.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A method for simulating raised-stone ornaments on a surface of three-dimensional decoration, and more particularly to a simulation method which can provide the raised-stone ornaments on the surface of decoration, using primarily a bonding agent, which can be eroded by pickling, to fill into a plurality of decorating stone crumbs for molding into an ornament, and performing a pickling on the surface of ornament to obtain an expected depth, after solidifying the ornament, thereby exposing out the stones at an external surface of ornament.

2. The method for simulating raised-stone ornaments on a surface of three-dimensional decoration according to claim 1, wherein the method includes a setup operation to make a pulp after mixing the bonding agent and the stone crumbs; the pulp being provided for a molding operation and a natural solidification reaction operation which will take about 20-48 hours together; a surface eroding operating being performed after solidifying, followed by performing a surface neutralization and a drying operation.

3. The method for simulating raised-stone ornaments on a surface of three-dimensional decoration according to claim 2, wherein a residual scrubbing is performed after accomplishing the surface eroding operation.

4. The method for simulating raised-stone ornaments on a surface of three-dimensional decoration according to claim 2, wherein in the setup operation, the bonding agent made by tuning a magnesium chloride solution and a magnesium oxide powder in a weight ratio of 1:1.2-1:1.5 is mixed into the stone crumbs.

5. The method for simulating raised-stone ornaments on a surface of three-dimensional decoration according to claim 2, wherein the molding operation is divided into a solid mold injection operation and a hollow shell molding operation.

6. The method for simulating raised-stone ornaments on a surface of three-dimensional decoration according to claim 2, wherein a pre-processing operation of the surface eroding operation is to prepare a 10% of aciding agent which is entered into a pickling tank after being diluted.

7. The method for simulating raised-stone ornaments on a surface of three-dimensional decoration according to claim 1, wherein the stone crumbs are natural stones of different colors.

8. The method for simulating raised-stone ornaments on a surface of three-dimensional decoration according to claim 1, wherein the stone crumbs are silicon grits of glass.

9. A formation for simulating raised-stone ornaments on a surface of three-dimensional decoration, more particularly a formation of three-dimensional raised-stone ornament simulating the raised decorating stone crumbs coated on a surface of decoration, using primarily a bonding agent to mix with the decorating stones, so as to form a three-dimensional decoration after setting, the characteristic being that a lower half of raised-stone is bonded by a body bonding agent and an upper half of raised-stone is exposed.

10. The formation for simulating raised-stone ornaments on a surface of three-dimensional decoration according to claim 9, wherein the decorating stone crumbs are at least bonded to the surface of body bonding agent with a single face.

11. The formation for simulating raised-stone ornaments on a surface of three-dimensional decoration according to claim 9, wherein the stone crumbs are natural stones of different colors.

12. The formation for simulating raised-stone ornaments on a surface of three-dimensional decoration according to claim 9, wherein the stone crumbs are silicon grits of glass.
